(19) United States
(12) Patent Application Publication
(10) Pub. No.: US 2018/0124557 A1
(43) Pub. Date: May 3, 2018

(54) NETWORK CONNECTED MARINE ELECTRONICS SYSTEM

(71) Applicant: Garmin Switzerland GmbH, Schaffhausen (CH)

(72) Inventors: Jesse A. Bartley, Kansas City, KS (US); Gregory J. Koch, Olathe, KS (US); Nathan L. Karstens, Olathe, KS (US); Veselin V. Georgiev, Olathe, KS (US)

(21) Appl. No.: 15/663,176

(22) Filed: Jul. 28, 2017

Related U.S. Application Data
(60) Provisional application No. 62/416,521, filed on Nov. 2, 2016.

(51) Int. Cl. H04W 4/02; G01C 21/20; H04L 12/28; H04W 36/32; B63C 11/42

(52) U.S. Cl. CPC H04W 4/02; G01C 21/20; B63J 2099/008; H04W 36/32; B63C 11/42; H04L 12/28

(57) ABSTRACT

A network connected marine electronics system has one or more marine electronic devices, a mobile software application for installation on a mobile communications device, and a remote cloud-based information system. Marine data on the user's mobile communications device can be synchronized with marine data on the user's marine electronic devices and vice versa using a wireless marine network onboard a marine vessel and without the need to connect to a remote server. Marine data on the mobile communications device can include marine data transferred to the mobile communications device from marine navigation devices on another boat of the user and can include marine data of other users in a user community who uploaded that marine data to the cloud-based information system and selected to share it with other users. The network connected marine electronics system enables definition of different user roles and permissions for different users.

### RELATED APPLICATION

The present application claims priority benefit under 35 U.S.C. § 119(e) of U.S. Provisional Patent Application Ser. No. 62/416,521, filed on Nov. 2, 2016, entitled “MARINE CONNECTIVITY FEATURES,” the entire disclosure of which is incorporated herein by reference.

### FIELD OF THE INVENTION

This disclosure generally relates to marine electronics and, more particularly, relates to updating and synchronizing marine data in marine electronic devices and systems.

### BACKGROUND OF THE INVENTION

Fixed marine networks for marine vessels enable marine electronics to be networked with cables to enable information entered on one marine electronic device to be updated on other devices connected to the network on the marine vessel. Wireless marine networks, such as marine networks employing Wi-Fi, enable wireless communications devices to wirelessly connect to the marine network using the wireless marine network. However, current marine network systems and technology do not enable boat operators to easily transfer marine data from marine electronics on a first boat to marine electronics on a second boat or to easily transfer to marine electronics marine data, such as marine data uploaded to one or more servers associated with an online community by members of the community that may be downloaded by such members for use on the marine electronics.

Embodiments of the present technology provide an electronic marine navigation system that enables improved techniques for the transfer of selected marine data stored on a mobile communications device of a boat operator. The mobile device may have obtained marine data from a server to which the marine data was uploaded by one or more users of an online community. The present technology further enables improved techniques for efficient data synchronization of marine data stored on a mobile communications device of the user and marine data stored in a marine electronics device or system on the user's boat and/or marine data stored on a server.

### SUMMARY OF THE INVENTION

A marine electronics navigation system includes an electronic navigation device for placement on a marine vessel. The marine electronics navigation system stores marine data, such as marine cartography data, marine navigation data, and marine user data. A mobile software application installed and executed on a mobile communications device enables the mobile communications device to wirelessly receive marine data or a data update over a first communications network from a remote electronic device, such as a remote electronic server or computing device. The system further enables data synchronization of the marine data or data update stored on the mobile communication device that was received from the remote electronic device and the data synchronization of marine data stored in the marine electronic navigation system, without connecting to a remote electronic server, using wireless communication functionality of a marine communications network located on the marine vessel.

In embodiments, a system includes a marine communications network, an electronic navigation device and a mobile communications device. The marine communications network enabling wireless communications functionality on a marine vessel. The electronic navigation device is installed on the marine vessel and includes a processor and a memory storing a first marine data set. The mobile communications device comprising a processor and a memory storing a second marine data set and a mobile software application including a set of instructions executed by the processor for synchronizing, using the marine communications network, the first marine data set stored on the electronic marine navigation device with the second marine data set.

In embodiments, the system determines whether a data set stored in the marine electronics navigation system matches a set of marine data that is stored in the mobile communications device. When the system determines that the data set stored in the marine electronics navigation system and the marine data set stored in the mobile communications device do not match, the system, using at least one processor of the marine electronics navigation system and the mobile communications device, creates a new data set based on a combination of at least a portion of the data sets. Each of the marine electronics navigation system and the mobile communications devices stores the created, new data set.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of selected components of a marine electronics navigation system in accordance with the present invention(s) and technology;

FIG. 2 is a diagrammatic plan view with block diagrams illustrating selected components of a marine electronics navigation system in accordance with the present invention(s) and technology;

FIG. 3 is schematic view of versions of data sets of marine data having corresponding data items and is particularly illustrative synchronization of marine data according to aspects of the present invention(s) and technology;

FIG. 4 is schematic view of versions of data sets of marine data having corresponding data items and is particularly illustrative of synchronization of marine data according to the present invention(s) and technology when a data item has been deleted from a data set being synchronized;

FIG. 5 is a flowchart that illustrates a computer-implemented method of the present invention(s) and technology for synchronizing marine data present on different electronic devices;

FIGS. 6 and 7 are flowcharts that illustrate steps of part of a user's use of a marine electronics navigation system that is constructed according to the present invention(s) and technology;

FIG. 8 is a flowchart that illustrates a portion of processing steps for updating marine data, in a marine electronics navigation system that is constructed according to the present invention(s) and technology, that has been submitted by one or more members of a user community;

FIG. 9 is a flowchart that illustrates steps of exemplary use of a marine electronics navigation system that is constructed according to the present invention(s) and technology for synchronizing marine data;

FIG. 10 is an exemplary screen display of a mobile communications device having an installed mobile application of a marine electronics navigation system that is constructed according to the present invention(s) and technology;

FIGS. 11-14 are additional exemplary screen displays of a mobile communications device having an installed mobile application of a marine electronics navigation system that is constructed according to the present invention(s) and technology and, in particular, are illustrative of displays at different zoom levels of digital maps having user data that has been uploaded by one or more members of a user community;

FIGS. 15-17 are additional exemplary screen display of a mobile communications device (with the mobile communications device shown) having an installed mobile application of a marine electronics navigation system that is constructed according to the present invention(s) and technology and, in particular, are illustrative of selected regions for downloading marine data;

FIG. 18 is another exemplary screen display of a mobile communications device having an installed mobile application of a marine electronics navigation system that is constructed according to the present invention(s) and technology;

FIG. 19 is another exemplary screen display of a mobile communications device having an installed mobile application of a marine electronics navigation system that is constructed according to the present invention(s) and technology;

FIG. 20 is another exemplary screen display of a mobile communications device having an installed mobile application of a marine electronics navigation system that is constructed according to the present invention(s) and technology;

FIG. 21 is another exemplary screen display of a mobile communications device having an installed mobile application of a marine electronics navigation system that is constructed according to the present invention(s) and technology;

FIG. 22 is another exemplary screen display of a mobile communications device having an installed mobile application of a marine electronics navigation system that is constructed according to the present invention(s) and technology;

FIG. 23 is another exemplary screen display of a mobile communications device having an installed mobile application of a marine electronics navigation system that is constructed according to the present invention(s) and technology;

FIG. 24 is another exemplary screen display of a mobile communications device having an installed mobile application of a marine electronics navigation system that is constructed according to the present invention(s) and technology; and

FIG. 25 is another exemplary screen display of a mobile communications device having an installed mobile application of a marine electronics navigation system that is constructed according to the present invention(s) and technology.

### DETAILED DESCRIPTION

In the following detailed description of example embodiments of the invention, reference is made to the accompanying drawings that form a part hereof, and in which is shown by way of illustration specific example embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art form the description. For example, a feature, structure, act, etc., described in one embodiment may also be included in other embodiments, but is not necessarily included. Thus, the present technology can include a variety of combinations and/or integrations of the embodiments described herein. Additionally, references to functionality performed by “the system” means a processor of an electronic navigation device (a marine electronic device), a processor of a mobile communications device, or a combination thereof.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

Embodiments of the present technology provide a marine electronic system that enables marine data, such as marine cartographic and/or navigation data, to be easily communicated or updated between an electronic navigation device (a marine electronic device) of the marine electronic system and a mobile communications device. In embodiments, the marine electronic system may be a marine navigation system. In particular, embodiments of the present invention(s) and technology provide a marine electronic system that enables one or more data sets of marine data, such as marine cartography and marine navigation data stored in a marine electronics device, to be easily transmitted to or synchronized with other data sets of marine data that are stored on a mobile communications device that is positioned at a location (brought near or onboard a marine vessel on which the marine electronic system is used) to communicate with a marine communications network located on the marine vessel. The data is synchronized between the marine electronic device and the mobile communications device using a wireless marine network enabling wireless communications onboard the marine vessel.

In one embodiment, a user of a network-connected marine navigation system of the present technology is an owner and operator of two boats, Boat A and Boat B. As part of the overall system of the present technology, each boat has a marine navigation system comprising at least one marine electronic device. Each boat also has a wireless local area network to which each marine navigation system, including an electronic navigation device (a marine electronic device), onboard that boat connects. The user has a mobile communications device, such as a smartphone or tablet computer, with wireless communication functionality enabling the mobile communications device to communicate via the local wireless area network. In embodiments, the user's mobile communications device has installed thereon and stored in a memory thereof a mobile software application associated with or configured to communicate with the marine electronic device of the marine navigation system.

The mobile communications device, having the mobile software application of the presently described technology and information associated with the wireless local area networks of each of the boats (e.g., wireless local area network ID, access password, etc.), enables efficient transfer and synchronization of marine data. For example, when the mobile communications device connects with the wireless local area network of Boat B, marine data that has been entered or received in the marine electronic device on Boat B is automatically transferred to the user's mobile communications device. If a memory of the mobile communications device does not include any marine data, the marine data stored on the marine electronic device is loaded into the memory. If the memory of the mobile communications device includes marine data, the stored marine data is synchronized with marine data stored in the marine electronic device. In this way, following data synchronization of the marine data, the marine electronic device on Boat B and the user's mobile communications device each store the same set of marine data. As a further example, once the user leaves Boat B and goes to Boat A with his or her mobile communications device, the mobile communications device connects with the wireless local area network on Boat A. After the mobile communications device and the marine electronic device are both connected to the wireless local area network of Boat A, marine data that has been stored (entered or received) in the marine navigation system on Boat A is synchronized with marine data that has been stored (entered or received) in the mobile communications device, which now includes the marine data that has been transferred or synchronized from the marine electronic device on Boat B.

Accordingly, the present technology enables a boat operator of two (or more) boats to keep his or her marine data synchronized across multiple marine electronic devices of marine navigation systems on different boats and on the user's mobile communications device. The present technology enables data synchronization in this highly distributed and dynamic network without requiring all devices to be continuously connected to the same network. Rather, the present technology enables (i) certain components of a first marine electronic system to be connected and data synchronized at a time or times with the user's mobile communications device via a first wireless local area network on a first boat and (ii) certain components of a second marine electronic system to be connected and data synchronized at a different time or times with the user's mobile communications device via a second wireless local area network on a second boat.

The present technology enables input of marine data into the mobile communications device in a variety of additional manners. For example, a user interface the mobile communications device may be used to manually input, edit, or delete marine data stored in a memory of the mobile communications device. Additionally or alternatively, the present technology enables marine data to be downloaded to the memory of the mobile communications device from a remote server (or servers) to which a plurality of users may have access. The downloaded marine data may include complete or partial (e.g., updates of) digital cartographic data for a geographic area (e.g., a body of water, combination of land and water, etc.). The downloaded marine data may include marine data that has been uploaded to the remote server(s) of the system from other electronic devices of the user or other users. In embodiments, the marine data may be stored on the remote server in association with a user account associated with the user. The downloaded marine data may include marine data that has been uploaded to the remote server(s) from one or more members of a user community who have selected to share their marine data with a user community that has access to the server(s). In this regard, the technology of the system enables the user to select one or more geographic areas for which the user desires to automatically receive marine data (including updates and notifications of updates) to the user's mobile communications device when the mobile communications device is connected, such as a by a cellular link or Wi-Fi, to the remote server(s). Additionally, the downloaded marine data may include information indicative of a portion of a body of water, a coastline or shoreline that is new. For instance, the geographic area may have previously lacked cartographic data). The marine data stored (entered or received) in a memory of the mobile communications device in any of these manners is available for transfer or synchronization according to the processes of the technology detailed herein.

Regarding the data synchronization enabled by the presently described technology, when a first marine data set stored in a memory of the user's mobile communications device is wirelessly synchronized with a second marine data set stored in a memory of a marine navigation system on a first boat, a processor of the mobile communications device and/or a processor of the marine electronic device first determines whether the two data sets are associated with the same version identifier. If the version identifiers match, then the marine data sets are considered the same and no data synchronization is necessary. However, when the marine data sets have different version identifiers, the processor of the mobile communications device and/or the processor of the marine electronic device identifies individual data items (which may themselves be sets of data) by an item identifier, identifies data items that must be transferred to a memory of the mobile communications device or marine electronic device and identifies data items that must be removed from the memory of the mobile communications device or marine electronic device.

When each of the marine data sets being transferred or synchronized include marine data corresponding to an identified item identifier, in one embodiment, the processor of the mobile communications device and/or the processor of the marine electronic device selects the marine data with a version identifier (i.e., data item version number) determined to be newer and corresponding to the identified item. The selected marine data is used or included in a resulting transferred or synchronized data set. In embodiments, when the data sets have the same data item version identifier for a particularly identified item, the processor of the mobile communications device and/or the processor of the marine electronic device analyzes the marine data in each data set corresponding to the particularly identified item to determine whether the data set is the same. If the data item version identifiers are the same, the identified data is used in the synchronized data set. When, however, the version identifiers for a particular item are equal but the processor of the mobile communications device and/or the processor of the marine electronic device determines the data associated with these equal identifiers is not the same in each data set, the processor(s) determines whether the data for this item can be synchronized by replacing one of the identified data items can be replaced or the identified items may be combined (merged). If the data can be combined, such as when the data item comprises a navigation route that has been modified in the different sets of data at two very different points on the route, the data for that item is combined and the combined data is used in the synchronized result. When, however, the system determines that the data (for an item that has a common identifier) in the data sets is different or inconsistent with each other, the processor of the mobile communications device and/or the processor of the marine electronic device selects the data from one of data sets (e.g., by selecting the data with the more recent timestamp) for use in the synchronized data. In another embodiment, when each of the marine data sets being synchronized has data corresponding to the identified item identifier, rather than selecting the data with the highest version identifier (e.g., version number), the system selects the data corresponding to the identified item that has the newer or more recent identifier or timestamp.

The marine navigation system and technology further enable configuration of the system to establish roles and related permissions or user privileges so that the owner/operator of a marine vessel can establish roles for different users. For example, the user can establish and manage roles and permissions for other users including particularly roles (such as a guest role) associated with mobile communications devices belonging to users other than owner/operator. In particular, when a mobile communications device initially connects to the wireless network on a marine vessel, the processor of the marine electronic device presents on a display one or more questions to associate a role or relationship for the mobile communications device or a user account associated with the mobile communications device. For example, a marine navigation device onboard a marine vessel may present a question on a display asking whether the user account associated with the mobile communications device belongs to the owner of the vessel. If the mobile communications device belongs to the owner, the account (and thus the mobile communications device associated with that account) may be given an ownership role and the resulting access privileges associated with that role. In embodiments, if the mobile communications device does not belong to the owner, the account may be given a Guest role. In an embodiment, a Guest role permits use of the Guest mobile communications device to transfer marine data from the Guest mobile communications device to the marine navigation device on the boat, but not vice versa. Embodiments include establishment of additional roles, such as a Captain role that has access privileges beyond those provided to a Guest but less than those provided to an Owner role.

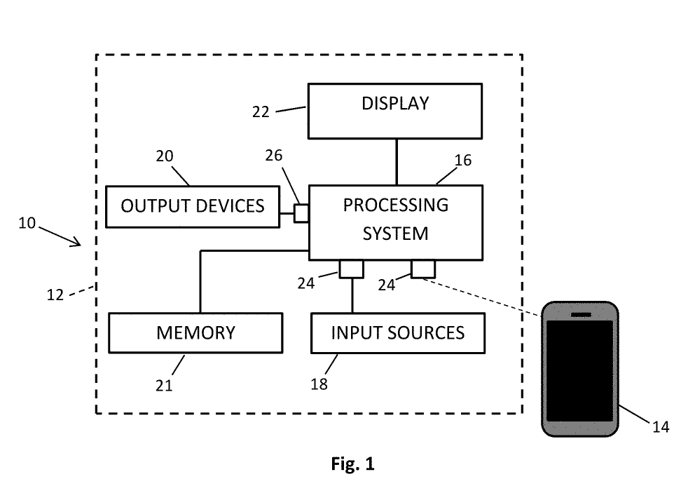

With reference now to the Figures and, in particular, with initial reference to FIG. 1, an electronic marine navigation system is denoted generally by reference numeral 10. The electronic marine navigation system 10 is generally comprised of a marine electronic device, such an electronic marine navigation device 12, and a mobile software application for installation on a mobile communications device 14. The electronic marine navigation device 12 is configured for mounting in a boat, ship, or other marine vessel. It should be understood that electronic marine navigation device 12 may be an integral electronic device or may be a system of multiple separate components that are interconnected and/or in communication with each other. It should also be understood that, for illustrative convenience, the system 10 is illustrated in FIG. 1 with a single electronic marine navigation device 12 and a single mobile communications device 14. However, system 10 may include multiple electronic devices that are in networked communication with each other and may include multiple mobile communications devices each having a mobile software application of the present technology installed thereon.

Electronic marine navigation device 12 has a processing system 16, input sources 18, output devices 20, and a display 22. Although one display 22 is illustrated for convenience, it should be understood that the electronic marine navigation device 12 can have multiple displays. Electronic marine navigation device 12 includes one or more inputs 24 and one or more outputs 26. Inputs 24 may be any wireless or wired device or devices or ports for receiving data from the input sources 18 and transferring the received data to the processing system 16. Outputs 26 may be also any wireless or wired device or devices or ports for transmitting data from the processing system 16 to one or more output devices 20. Input/outputs 24/26 may be integral components and may include, without limitation, on or more Ethernet ports, USB ports, memory card slots, video ports, radio frequency (RF) transceivers, infrared (IR) transmitters and/or receivers, Wi-Fi transceivers, wireless network routers, Bluetooth devices, etc. Input sources 18 may be buttons, keys, and/or touch screens for manual human input of selections and/or information and/or may be sensors (such as a temperature sensor, a transducer, etc.). As illustrated, an input source is mobile communications device 14 which, in embodiments, forms part of system 10. Output devices may include additional displays (such as display 22) and memory devices. Electronic marine navigation device 12 may also have an internal memory 21.

In embodiments, electronic marine navigation device 12 is or includes one or more of a chartplotter, a fish finder, a sonar depth sounder, a digital map display, a radar, a communications device, a radio, an electronic marine navigation aid, an electronic information station, and an entertainment system (for providing information, weather, and/or entertainment). An example of an electronic marine navigation such as the device 12 is illustrated and described in U.S. Patent Publication No. 2013/02781301, published Oct. 17, 2013, entitled MARINE VESSEL DISPLAY SYSTEM, which is incorporated in its entirety herein by reference.

Mobile communications device 14 is a mobile, wireless communications device such as a smartphone or tablet computer. As is well understood, mobile communications device 14 has an operating system, a display, inputs, and a touchscreen and, in embodiments, a microphone and a speaker. Mobile communications device 14 includes pre-installed mobile software applications and enables additional mobile software applications to be downloaded to the mobile communications device 14. In accordance with the present technology, system 10 includes a mobile software application for downloading and/or installation on a mobile communications device of a user, such as the illustrated mobile communications device 14.

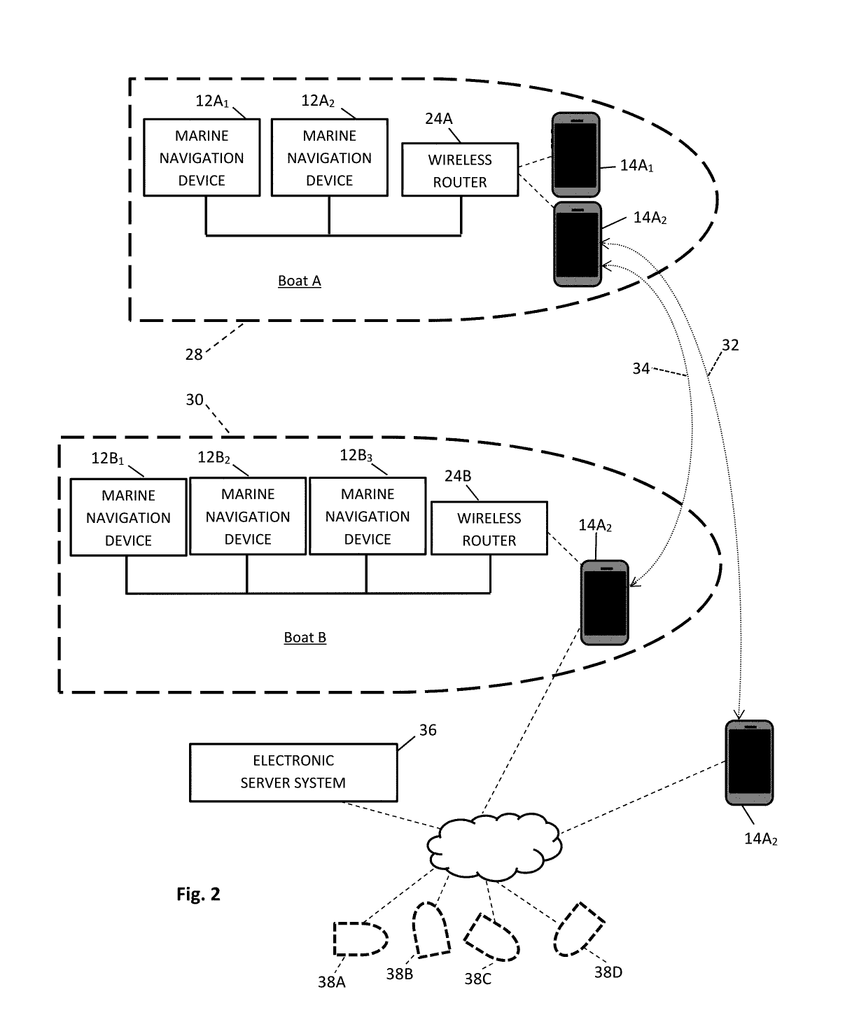

With reference to FIG. 2, system 10 is further illustrated and described. A first boat, Boat A, is illustrated graphically by broken line 28 and a second boat, Boat B, is illustrated graphically by broken line 30. Each of Boats A and B are owned and/or operated by a user of system 10. As will be appreciated, Boats A and B may be the same type of boat or may be different types of boats (e.g., one a sailboat and one a yacht). Boat A has a first networked electronic marine navigation system 10A having a first electronic marine navigation device 12A1 and a second electronic marine navigation device 12A2, and a wireless router 24A. In embodiments, an operator of Boat A has a first mobile communications device 14A1 and a second mobile communications device 14A₂. Boat B has a second networked electronic marine navigation system 10B having a first, a second, and a third electronic marine navigation device, denoted respectively by reference numerals 12B1, 12B2 and 12B3, and a wireless router 24B. In embodiments, mobile communications devices 14A1 and 14A₂ may be used by the same user and have the same roles/permissions in systems 10A and 10B. In other embodiments, mobile communications devices 14A1 and 14A₂ may each be used by a different user and/or have different roles/permissions (such as owner and guest) in systems 10A and 10B.

As illustrated and as particularly indicated by motion line 32, mobile communications device 14A₂ is moved off of and onto Boat A as the user thereof gets on and off of Boat A. For example, the user of mobile communications device 14A₂ may dock Boat A and go onshore (with the mobile communications device 14A₂) and then later return to the Boat A (with the mobile communications device 14A₂). As further illustrated and as particularly indicated by motion line 34, mobile communications device 14A₂ is moved off of Boat A and onto Boat B. It will be appreciated that this movement between Boats A and B could be at substantially the same moment in time (such as the two boats A and B being pulled along-side of each other or docked nearby each other and the user is merely stepping from one boat to the next) or the movement between Boats A and B may involve entirely different locations and times. For example, the user of mobile communications device 14A₂ may be the owner of Boat A and Boat B. In some instances, Boat A and Boat B may be in the same general geographical location or region (i.e., docked or stored in or at the same harbor or dock for use on the same body of water). In other instances or alternatively, the Boats A and B may be located at different geographical locations and even on different bodies of water.

As described herein, the owner of Boats A and B may use mobile communications device 14A₂ to receive marine data from the marine electronic navigation system 10A on Boat A and then subsequently transfer that received marine navigation data (or at least portions thereof that are not already updated on system 10B on Boat B) from the mobile communications device 14A₂ to the marine electronic navigation system 10B on Boat B. Additionally, the mobile communications 14A₂ , having the mobile software application of the present technology installed thereon, enables receiving marine data updates from System 10B on Boat B and then subsequently transferring those updates to System 10A on Boat A. In such a way, updates made to marine data in one of System 10A and 10B can be synchronized with data stored in the other of System 10A and 10B, even though the Systems 10A and 10B are not directly networked in real-time or always or regularly connected to remote servers or cloud-based storage solutions.

Additionally, system 10 includes a remote electronic server system 36. Remote electronic server system 36 may, in commercial practice, be and will likely comprise a plurality of electronic servers in a cloud-based information processing and data storage system. In embodiments, electronic server system 36 is provided and operated by a provider of system 10 and, in particular, is provided by a provider of the electronic marine navigation devices 12 and/or a provider of the mobile software application. In embodiments, system 10 is an integrated system such that the marine electronic navigation device or system 12, the mobile software application for installation on the mobile communications device 14, and the remote electronic server system 36 are provided and maintained by a common provider. As described herein, remote electronic server system 36 enables the user of system 10 to set-up an online accessible account for use in managing aspects and features of system 10, such as user permissions and roles, preferences, cartography subscriptions, etc.

Additionally, in embodiments in which the mobile communications device 14A₂ is a cellular communications device and the mobile communications device 14A₂ has access to a cellular network, mobile communications device 14A₂ may connect using wireless cellular communications with electronic server system 36 and be used by the user to manage system 10. Similarly, as will be understood and appreciated, mobile communications device 14A₂ may access electronic server system 36 when mobile communications device 14A₂ has access to a wireless local area network (LAN), such as a Wi-Fi network, which provides access to a wide-area network for communicating with electronic server system 36. Mobile communications device may transfer and receive data from electronic server system 36 using any desired protocol, such as a protocol for transferring data over the Internet.

Further, as described herein, electronic server system 36 of system 10 receives marine user data from a plurality of members of a user community. This user community is represented in FIG. 2 by vessels 38A, 38B, 38C and 38D. As will be appreciated, the four vessels 38A-38D are shown for illustrative purposes and the number of users in the user community will vary and will likely be significantly greater than four in number. At a minimum, each of these vessels or its owner, operator, and/or user has at least one of the electronic navigation devices 12 and mobile communications devices 14 of system 10. For example, each of the marine vessels 38A-38D has at least one marine navigation device 12. Marine user data (such as waypoints, points-of-interest, boundaries, navigation routes, paths, tracks, etc.) received or entered into the marine navigation devices 12 onboard vessels 38A-38D may be uploaded to the corresponding user's account hosted at electronic server system 36 and then shared (at the optional selection of that user) with an online user community having features that are hosted by electronic server system 36. Marine user data may be uploaded to the electronic server system 36 by connecting a marine electronic device to a personal computer that is connectable to a wide area network, by inserting a removable data card taken from the marine electronic device into a personal computer that is connected to a wide area network, or by transferring the marine user data to a mobile communications device 14 according to the presently described technology and then using the mobile communications device 14 to upload the received marine user data to the electronic server system 36. Additionally, mobile communications device 14A₂ may be used by its user to download selected portions of the marine user data that has been uploaded to electronic server system 36 by other users. As described herein, such downloads can occur automatically following uploading of the marine user data when the mobile communications device 14A₂ is connected to electronic server system 36, and/or according to a periodic update schedule, and/or in response to a notification to the mobile communications device 14A₂ that marine user data updates are available for download. This downloaded marine user data of one or more users of the user community is then available in the mobile communications device 14A₂ to be synchronized with the marine data in system 10A and system 10B when the mobile communications device 14A₂ connects, respectively, with the wireless router 24A onboard Boat A and the wireless router 24B onboard Boat B. Additionally, mobile communications device 14A₂ may be used by its user to modify (e.g., edit or delete) items of marine user data stored in the mobile communications device. Such modifications may, for example, be made to user data that mobile communications device 14A₂ has received from system 10A or 10B (or other systems) or that has been downloaded to the mobile communications device 14A₂ from electronic server system 36.

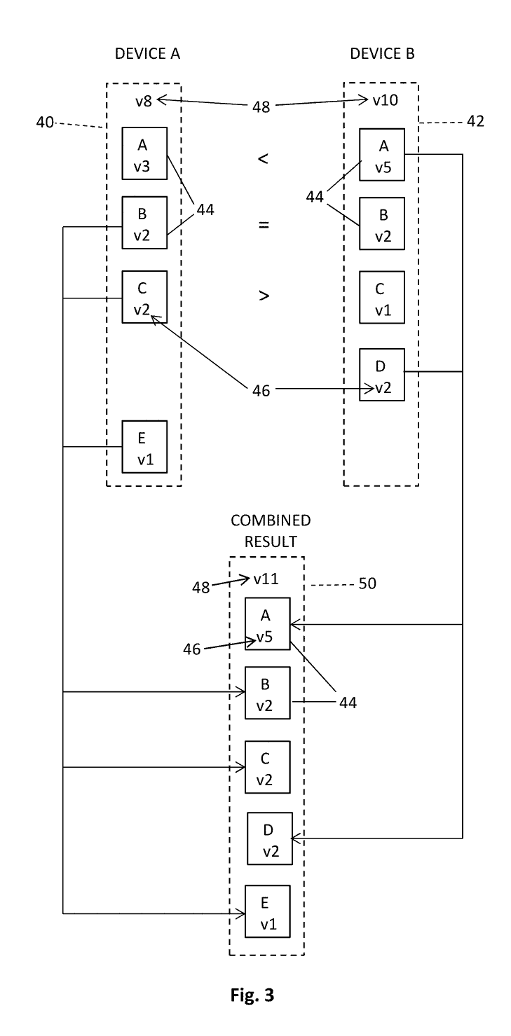

With reference to FIG. 3, marine data synchronization functionality of the present technology is more particularly illustrated and described.

Marine data in a DEVICE A and marine data in a DEVICE B are synchronized. As will be appreciated in view of the present specification, one of DEVICE A and DEVICE B is a mobile communications device 14 having the mobile software application of the present technology installed thereon and the other of DEVICE A and DEVICE B is an electronic marine navigation device 12 (or system). For example, DEVICE A may be an electronic marine navigation device 12 of Boat A and DEVICE B may be a mobile communications device 14. When the user of DEVICE B, a mobile communications device 14 in this example, is at the same location as Boat A and the DEVICE B (mobile communications device 14) and the DEVICE A (marine navigations device 12 onboard Boat A) are connected to the wireless network enabled by wireless router 24A and are therefore enabled to communicate (send and receive) data using the wireless network, data synchronization is automatically initiated. Alternatively, data synchronization is initiated only when the mobile software application of the present technology is open and the mobile communications device 14 on which the software application is running is connected to the corresponding wireless marine local area network. Alternatively and/or additionally, system 10 operates to provide a notification to the mobile communications device 14 and/or marine electronics device 14 that the devices are connected and that data is or may be available for synchronization.

DEVICE A has a data set of marine data and, in particular, marine user data denoted generally by reference numeral 40. DEVICE B has a data set of marine data and, in particular, marine user data denoted generally be reference numeral 42. Marine data sets 40, 42 each have a plurality of items 44 which are also denoted alphabetically, such as items A, B, C, D, and E. Each item 44 comprises a marine user data item, such as a waypoint, a labeled or marked point-of-interest, a boundary, a historical path that has been traveled by a marine vessel, a navigation route, etc. Each item 44 is identified by a unique identifier, such that item A as stored in DEVICE A and item A as stored in DEVICE B have a common, unique identifier such as a universally unique identifier (UUID). As illustrated, each item 44 also has a corresponding version identifier 46, such as an item version number, and each data set 40, 42 has a corresponding version identifier 48, such as a data set version number.

When system 10 detects that each of DEVICE A and DEVICE B are connected to the network of Boat A, system 10 synchronizes the data sets 40 and 42 by combining the data of the data sets 40, 42 and creating a new data set 50. Alternatively or additionally, system 10 prompts the user with a notification to one or both of devices 12, 14 to enable synchronization.

The new data set 50 has a data set version identifier 48 that is one greater than the greater data set version identifier of the data sets 40, 42 being combined. A data synchronization process of the present invention(s) and technology may first consider the data set version identifiers 48 of each data set 40, 42 to determine if they are the same. If the data set version identifiers 48 are the same, then system 10 may determine that the data in each of DEVICE A and DEVICE B is the same and that no further data synchronizations steps are necessary.

When system 10 determines that data set version identifiers 48 of the data sets 40, 42 in DEVICES A and B, respectively, are not the same (as in the example illustrated in FIG. 3 having data set version identifier v8 for data set 40 in DEVICE A and data set version identifier v10 for data set 42 in DEVICE B), then system 10 compares the item version identifiers 46 for each identified item 44. In particular, using the example data sets 40, 42 in FIG. 3, system 10 compares the corresponding item version identifiers 46 for each of identified items A, B, and C which are found in both of data sets 40, 42. Additionally, system 10 determines that item D (having a unique identifier and being present in data set 42 of DEVICE B) is not present in data set 40 of DEVICE A) and that item E (having a unique identifier and being present in data set 40 of DEVICE A) is not present in data set 42 of DEVICE B. In conducting this analysis, system 10 determines (i) that the version of the data for item A in DEVICE B (v5) is greater than the version of the data for item A in DEVICE A (v3), (ii) that the version of the data for item B in DEVICES A and B is the same (v2), and (iii) that the version of the data for item C in DEVICE A (v2) is greater than the version of the data for the item C in DEVICE B (v1). Accordingly, system 10 synchronizes the data sets 40, 42 by generating a new data set 50 having the version of the data of item A from data set 42 of DEVICE B (v5), the version of the data of item C from data set 40 of DEVICE A (v2), the version of the data of item D from the data set 42 of DEVICE B (v2), and the version of the data of item E from the data set 40 of DEVICE A (v1).

Regarding the data corresponding to the item identified as item B, a case in which the version numbers are the same, system 10 performs additional operations to determine whether the data in data sets 40 and 42 for item B are the same. In the case in which the data in each of data sets 40, 42 are the same, then that data is used in the new data set 50. However, it is possible that the data corresponding to item B has been updated separately (such as in the marine electronic device 12 on Boat A and on the mobile communications device 14 or on Boat B from where mobile communications device 14 may have received data set 42). In such a case, when system 10 determines that the data corresponding to item B has been updated to v2 in different manners, the system 10 determines whether the data can be combined to include the data updates from both data set 40 and data set 42. For example, in a case in which item B comprises data corresponding to a navigation route and a modification in data set 40 of DEVICE A is to one point in the route and a modification in data set 42 of DEVICE B is to another point in the route, then each of those modifications may be used in the data for item B to be included in the newly created data set 50 (in which case that item version identifier for item B would be updated to v3). In other scenarios, data modifications on different devices to the same identified item may be inconsistent with each other and it is not possible for system 10 to include both modifications. In such a scenario, system 10 breaks the tie between the version identifiers using a timestamp associated with the item 44 (such as item B in this example). In particular, in one embodiment, the data that has been most recently updated is used in the new data set 50 and the version number (v2 in this example) remains the same. In this regard, each electronic marine navigation device 12 and mobile communications device 14 in system 10 has a clock that keeps time at least substantially in common with all other electronic marine navigation devices 12 and mobile communications devices 14 in system 10.

The new data set 50 (i.e., the combined resulting from data synchronization) is stored in each of DEVICES A and B. In accordance with an embodiment of the present technology, only data that needs to be updated in a device is transmitted from one device to the other, thereby conserving bandwidth resources on the network used in and/or by system 10. As just one example of this bandwidth conservation feature, data corresponding to item A (v5) need only be transmitted from DEVICE B to DEVICE A since DEVICE B already has the version (v5) for item A resulting from the marine data synchronization.

Accordingly, the present technology employs a data structure that indicates one or more of a version identifier of a set of marine data, a plurality of unique identifiers each corresponding to a marine data item (or subset of marine data), an item version identifier that indicates the current version of each marine data item, historical version information for each marine data item, identification of actions for each marine data item (actions may include creation of the item, modifications to the item, deletion of the item, etc.), and date/timestamp information for each identified action.

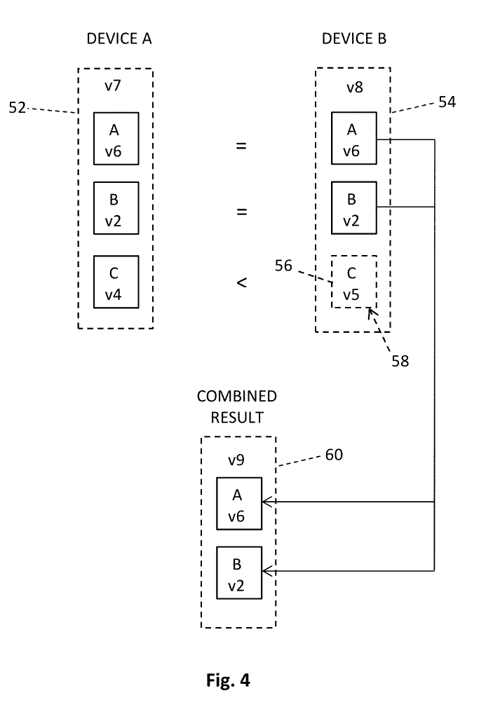

With additional reference to FIG. 4, illustrated is an example of data synchronization of data sets 52 (DEVICE A) and 54 (DEVICE B) in which data for an identified item C, as denoted by reference numeral 56, has been deleted.

System 10 maintains information indicative of the deleted data for item C, including the item version identifier 58 for the deleted item C, in data set 54 of DEVICE B. Accordingly, since the version of the data for item C as deleted in DEVICE B (v5) is greater than the version of the data for item C in DEVICE A (v4), data for item C is not included in the combined data set 60.

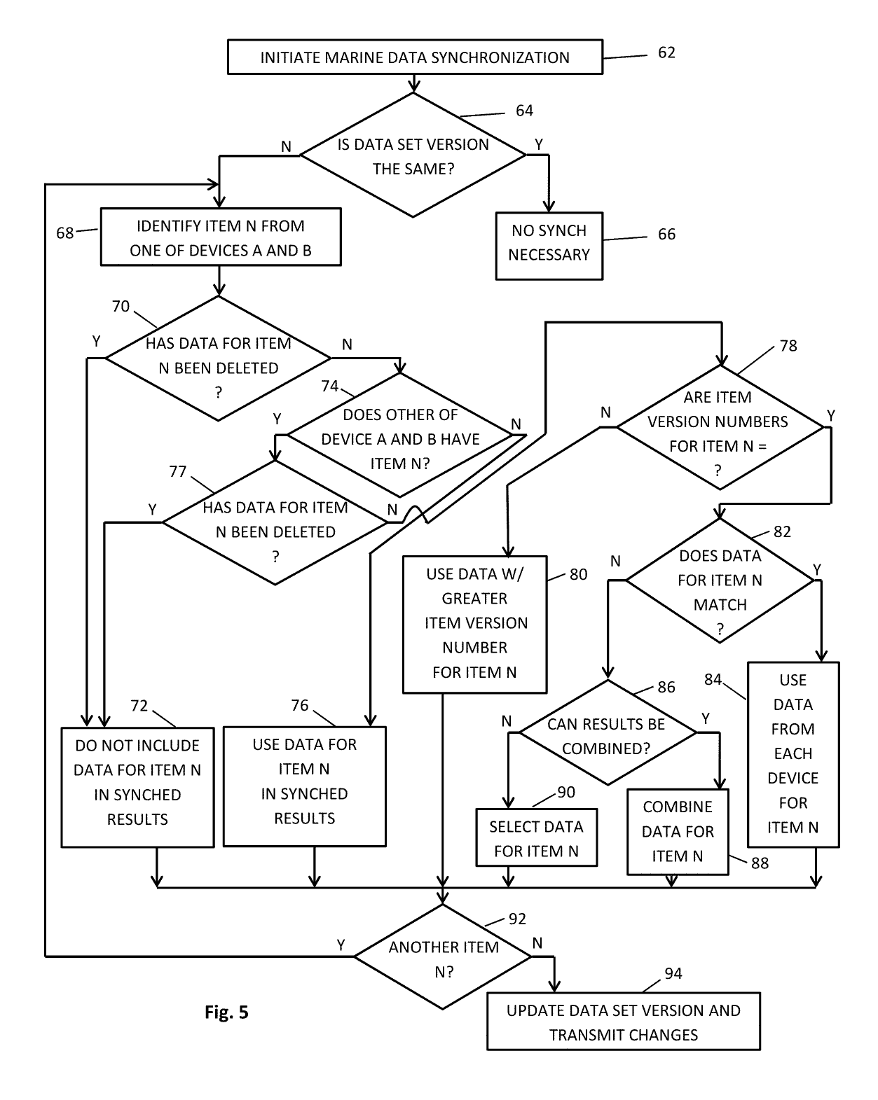

With reference to FIG. 5, the described data synchronization functionality of the present technology is illustrated and described according to a computer-implemented method. In an embodiment, a marine electronic navigation device or system 12 receives information indicative of marine data from mobile communications device 14 and processes data synchronization steps. In an embodiment, mobile communications device 14 receives information indicative of marine data from marine electronic navigation device or system 12 and processes data synchronization steps. In an embodiment, each of device (or system) 12 and mobile communications device 14 receives information indicative of marine data from the other device and processes data synchronization steps. The following description of a computer-implemented method is for illustrative purposes and includes steps relating to data synchronization features of the present invention that, where appropriate, could be performed differently or in different sequence than described to achieve the same result. Accordingly, the following described computer-implemented method is illustrative and non-limiting.

At step 62, system 10 initiates marine data synchronization of the marine data on devices 12 (DEVICE B), 14 (DEVICE A).

At step 64, system 10 determines if the data set version identifier of the marine data on DEVICE A is the same as the data set version identifier of the marine data on DEVICE B. When it is determined at step 64 that the data set version identifier of the marine data on DEVICE A is the same as the data set version identifier of the marine data on DEVICE B, no marine data synchronization is necessary, as indicated at step 66. When it is determined at step 64 that the data set version identifier of the marine data on DEVICE A is not the same as the data set version identifier of the marine data on DEVICE B, processing advances to step 68.

At step 68, system 10 identifies a first item, item N, from one of DEVICES A, B.

At step 70, system 10 determines whether the data corresponding to item N on the one of DEVICES A, B has been deleted. When system 10 determines at step 70 that the data corresponding to item N on the one of DEVICES A, B has been deleted, the data for item N is not included in the synchronized results, as indicated at reference numeral 72. When, however, system 10 determines at step 70 that the data corresponding to item N on the one of DEVICES A, B has not been deleted, processing advances to step 74.

At step 74, system 10 determines whether the other DEVICE A, B also has or has had data indicative of item N stored thereon. When it is determined at step 74 that the other DEVICE A, B has not had data indicative of item N therein, processing advances to step 76 and the data for item N in the one of DEVICE A, B that has data therein for item N is used in synchronized data results, as indicated at step 76. When, however, it is determined at step 74 that the other DEVICE A, B has or has had data indicative of item N therein, processing advances to step 77.

At step 77, system 10 determines whether the data for item N in the other device A, B has been deleted. When system 10 determines at step 77 that the data for item N in the other device A, B has been deleted, the data for item N is not included in the synchronized results, as indicated at reference numeral 72. When, however, the system 10 determines at step 77 that the data for item N in the other device A, B has not been deleted, then processing advances to step 78.

At step 78, system 10 determines whether the version item identifier (e.g., number or other identifier) for item N is the same in each of DEVICES A and B. When system 10 determines at step 78 that the version item identifier (e.g., number or other identifier) for item N is not the same in each of DEVICES A and B, processing advances to step 80 and system 10 uses the data associated with the greater item version identifier for item N. When system 10 determines at step 78 that the version item identifier (e.g., number or other identifier) for item N is the same in each of DEVICES A and B, processing advances to step 82.

At step 82, system 10 determines whether the data for item N in each of DEVICES A and B matches. When system 10 determines at step 82 that the data for item N in each of DEVICES A and B matches, system 10 uses the data from each device for the item N in the data synchronization (i.e., the data matches so each device retains matching data for item N), as illustrated at box 84. However, when system 10 determines at step 82 that the data for item N in each of DEVICES A and B does not match, processing advances to step 86.

At step 86, system 10 determines whether the non-matching data for item N in DEVICES A and B can be combined. When system 10 determines at step 86 that the non-matching data for item N in DEVICES A and B can be combined (i.e., the data is not inconsistent with each other such as modifications to two entirely different points on a path or navigation route), system 10 combines the data for item N (i.e., system 10 modifies the data set or item N to include both data from DEVICE A and DEVICE B for item N), as illustrated at step 88. When system 10 determines at step 86 that the non-matching data for item N in DEVICES A and B cannot be combined (i.e., the data is inconsistent with each other such as modifications to the same waypoint or points on a path in inconsistent manners) system 10 selects one of the data sets from DEVICES A or DEVICE B for item N, as illustrated at step 90. This selection may, for example, be based on a comparison of timestamps associated with actions corresponding to the item in each of DEVICE A and DEVICE B.

At step 92, system 10 determines whether there is another item N in the marine data sets of either of DEVICES A and B. When system 10 determines at step 92 that there is another item N in the marine data sets of either of DEVICES A and B, processing returns to step 68 to process the next item N. When system 10 determines at step 92 that there is not another item N in the marine data sets of either of DEVICES A and B, processing advances to step 94.

At step 94, the data set version identifier is updated and the newly created synchronized data set is transmitted to each of DEVICES A and B. In accordance with the technology, to conserve bandwidth in the wireless marine network, only those data items requiring an update in a DEVICE A, B are transmitted to the DEVICE A, B, from the other DEVICE A, B.

As described, in embodiments, system 10 uses item version identifiers 46 (see FIG. 3) to make a determination of the data to be used in the synchronized data result. In particular, the higher version number for a particular item of data is used in the new, combined data set 50 that results from data synchronization of data sets 40, 42. Alternatively, or additionally, system 10 could use a timestamp associated with each data item 44 in making a determination of which data to use in the combined data set 50. As an example, assume that the data in data set 42 of DEVICE B (FIG. 3) came from Boat B (see FIG. 2) and that the user is the owner of Boats A and B. Assume further that the user frequently uses Boat B and has updated the data of item A to its 5^{th} version, as shown in FIG. 3, and that data was transmitted to mobile communications device 14 (i.e., DEVICE B). However, assume further that the owner has not gone to Boat A with his or her mobile communications device 14 (DEVICE B) and, subsequent to updating the data of item A on Boat B to version 5 (v5), the owner of Boat A updated on marine electronic device 42 onboard Boat A the data of item A to version 3 (v3). In such a case, during a subsequent synchronization of the data on DEVICES A and B, the data item A on DEVICE B (mobile communications device 14) has a higher version number (v5) that the data for item A on DEVICE A (electronic device 42 on Boat A), but the data for item A on DEVICE A has been updated more recently than the data for item A on DEVICE B (as determinable by a comparison of time stamps for the respective data for item A in DEVICES A and B). In such a case in this alternative embodiment, the data for item A to be used in the combined data set 50 is the more recently updated version 3 (v3) data in data set 40 in DEVICE A. Similarly, in the example of FIG. 4 in which the data for item C has been deleted in DEVICE B, in the event that the deleted version (v5) of the data for item C in DEVICE B had a timestamp that is earlier in time than a timestamp associated with the version of data for item C in DEVICE A (i.e., v4), such as a timestamp corresponding to the time that the data for item C in DEVICE A was updated to version 4, then the data associated with item C in DEVICE A (i.e., v4, DEVICE A) will be used in the combined, synchronized data set 60.

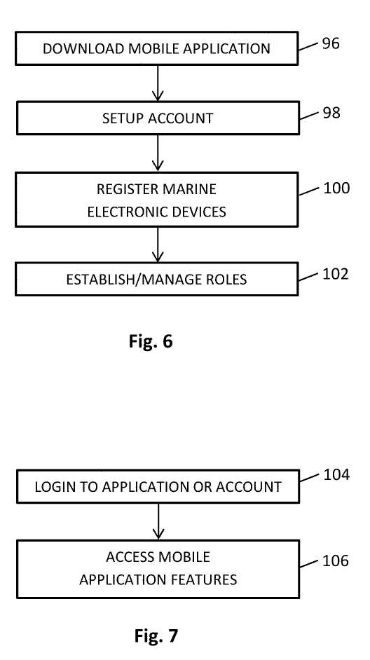

With additional reference to FIGS. 6 and 7, use of system 10 is further illustrated and described.

At step 96 of FIG. 6, the mobile application of the present technology is downloaded to a mobile communications device 14 of the user. As will be understood, the mobile application is a software application that may be downloaded from electronic server system 36 of system 10 or may be made available via a mobile application store of a mobile provider, such as (but not limited to) mobile application stores for downloading iOS-based mobile applications and Android®-based mobile applications.

At step 98, system 10 receives information indicative of account set-up by the user. In particular, the user sets up an account in system 10, such as by accessing electronic server system 36 using the mobile communications device 14 or another connected device (such as a personal computing device). Account set-up, as indicated at step 98, may occur before or after the mobile software application is downloaded to mobile communications device 14. Account set-up may include (but is not limited to) one or more of entering a user's actual name, a user name, a password, an address, a telephone number, and providing payment credentials. Account set-up may further include one or more prompts during set-up as well as confirmation messages displayed on a display of the device from which the user is establishing the account as well as electronic messages sent to a mobile device and/or an email account.

At step 100, system 10 receives information indicative of user registration of marine electronic devices 12. In particular, the user registers his or her marine electronic devices 12 with the account by entering information indicative of marine electronic devices 12 including one or more registration codes.

At step 102, system 10 receives inputs from the user device regarding roles and permissions to be associated with mobile communications device 14. The user can establish and manage roles and permissions for other users including particularly setting-up roles (such as a guest role) associated with other mobile communications devices 14 other than the user's mobile communications device 14. The account also enables the user to register cartography versions and to manage subscriptions to digital cartography used or to be used on the user's mobile communications device(s) 14 and marine electronic device(s) 12.

An aspect of the present technology enables the owner/operator of a marine vessel to establish roles for users. When a mobile communications device 14 first connects to the wireless network on a marine vessel, system 10 prompts the marine electronic navigation device 12 to display one or more questions to determine the relationship that the user account associated with the mobile communications device 14 just connected has with the marine vessel. For example, marine electronic device or system 12 may present a question asking whether the user account associated with the mobile communications device is associated with the owner of the marine vessel. If the user account is associated with the owner of the vessel, then the user account (and as such the mobile communications device associated with that user account) is given an ownership role and the resulting access privileges associated with that role; otherwise, the account is given a Guest role. In an embodiment, a Guest role permits use of the Guest mobile communications device 14 to transfer marine user data from the Guest mobile communications device 14 to the marine electronic navigation device or system 12, but not vice versa. Embodiments include establishment of additional roles, such as a Captain role that has access privileges beyond those provided to a Guest but less than those provided to an Owner role.

With additional reference to FIG. 7, as illustrated at step 104 FIG. 7, system 10 receives information indicative of a user login. In particular, the user, using mobile communications device 14 with the mobile software application of the present technology installed thereon, logs-in to his or her account and/or mobile application and accesses features of the mobile application and system 10, as illustrated at step 106. For example, after logging-in, the user can manage cartography subscriptions, manage user roles and preferences, register additional electronic marine navigation devices 12, register additional mobile communications devices 14, update account information, upload marine user data from the mobile communications device 14 to the user's account, modify marine user data, make selections regarding whether to share the user's marine user data with others in a user community or maintain it privately, etc.

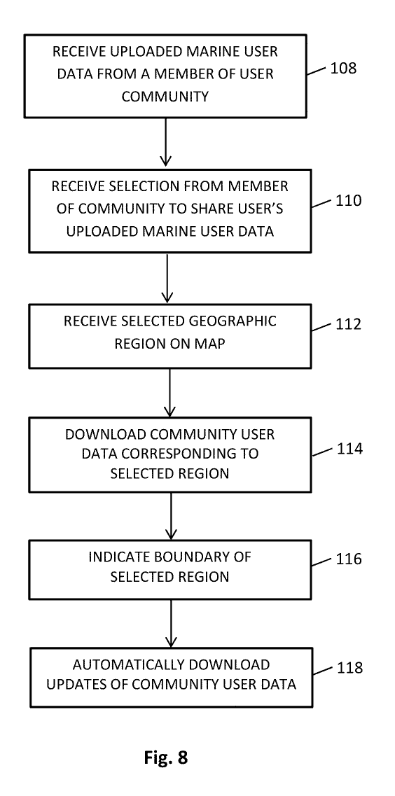

With additional reference to FIG. 8, features of the technology of system 10 related to receiving user data that is uploaded from members of a user community and to selecting geographical regions for which the uploaded user data is to be downloaded to mobile communications device 14 are illustrated and described.

At step 108, system 10 receives marine user data from a user of a user community. For example, system 10 may receive marine user data from a user of vessel 38A as illustrated and described above with reference to FIG. 2. The received user data (such as waypoints, points-of-interest, boundaries, navigation routes, historical paths, tracks, etc.) is stored in a memory of system 10, such as memory 21 of marine electronic device or system 12.

As step 110, system 10 receives a selection from the user of the community who uploaded the user data to share the uploaded user data (i.e., a selection to make the uploaded user data available to other users of the user community).

At step 112, system 10 receives from mobile communications device 14 of the user (or from another electronic device of the user) an indication of a boundary of a selected geographic region as drawn by the user on a digital map display using the mobile communications device 14 (or other electronic device).

At step 114, system 10 downloads to the mobile communications device marine user data that has been uploaded to system 10 and that corresponds to the geographic region input by the user.

At step 116, system 10 draws a boundary of the selected region on a display of the user's mobile communications device 14 (or other electronic device) to indicate the region for which marine data has been downloaded.

At step 118, at an additional time, system 10 automatically downloads additional marine data that has been uploaded to the electronic server system 36 by one or more members of the user community for the defined region.

Accordingly, system 10 enables a user of system 10, such as an operator of a boat, to select or subscribe to different regions and to automatically receive data updates to selected/subscribed regions that are uploaded by members of the user community. As described, when user-community marine data is uploaded by a user of the user community from that user's electronic device corresponding to a region that has been previously selected by the user of mobile communications device 14, the mobile communications device 14 of the user of system 10 who has subscribed to user community marine data updates from that region is notified that the region contains new user-community marine data updates for download and/or that newly uploaded user community marine data is automatically downloaded to mobile communications device 14 when mobile communications device 14 is connected to electronic server system 36. In this way, system 10 enables the user to establish regions to which the user is subscribed for future user-community updates and to be electronically notified when such updates occur (thereby enabling the user to respond to the notification and receive a download of the updates) and/or to automatically receive downloads to the user's mobile communications device 14 when such updates occur or according to a periodic update schedule. The user can add additional regions for receiving user community data and can cancel previously added regions. Additionally, cartography updates to digital cartography to which the user has subscribed can be provided from the electronic server system 36 to mobile communications device. In an embodiment, marine data updates, such as marine cartography updates, within a user-selected or predetermined range of a known home- or harbor-location for a user's marine vessel are provided to a user's system 10. Additionally, in embodiments, the downloaded data may include data indicative of a portion of a body of water or a coastline or shoreline that has not previously been charted or is not available in the cartographic data of the system and is charted by a member of a user community and uploaded by the member to the server(s) of the system.

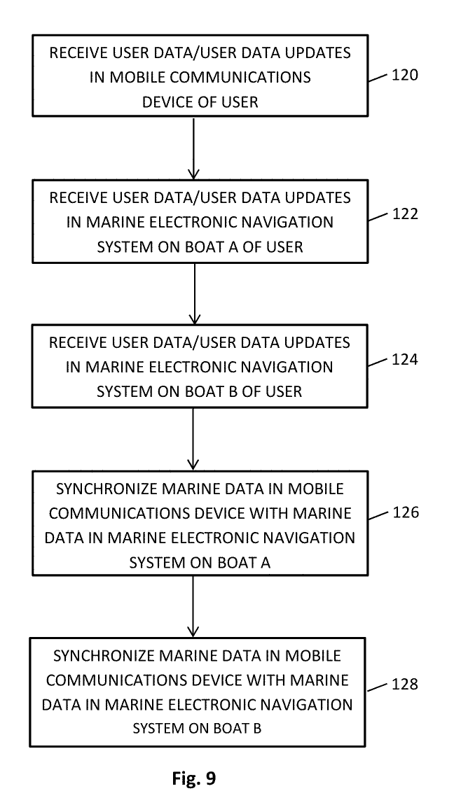

With additional reference to FIG. 9, further use of system 10 is illustrated and described and, in particular, exemplary use of system 10 by an owner of two boats, such as Boats A and B of FIG. 2, is illustrated and described.

At step 120, mobile communications device 14 of the user initially receives marine user data or receives an update to previously received marine user data. As will be understood from the disclosure herein, such marine data/marine data update may be wirelessly received or may be entered using an input of the mobile communications device 14 in conjunction with the mobile software application of the present invention.

At step 122, marine electronic navigation device or system 12 of the user onboard Boat A initially receives marine user data or receives an update to previously received marine user data, such as by (but not limited to) entry by the user using an input 24 of marine electronic navigation device or system 12.

At step 124, marine electronic navigation device or system 12 of the user onboard Boat B initially receives marine user data or receives an update to previously received marine user data, such as by entry by (but not limited to) the user using an input 24 of marine electronic navigation device or system 12.

At step 126, system 10 synchronizes as described herein the marine data in the user's mobile communications device 14 with the marine data in the marine electronic navigation device or system 12 on Boat A.

At step 128, system 10 synchronizes as described herein the marine data in the user's mobile communications device 14 (which now includes any updates from the synchronization with the marine data in the electronic device 12 on Boat A) with the marine data in the marine electronic navigation device or system 12 on Boat B.

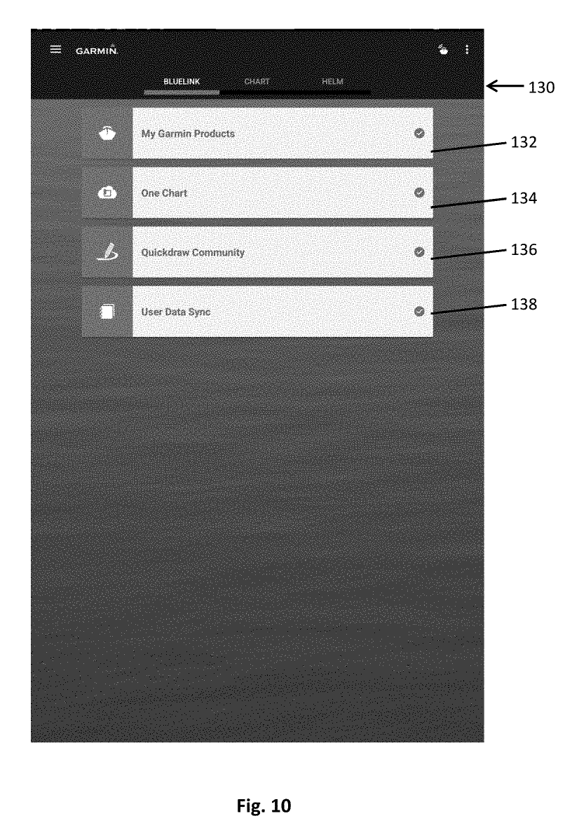

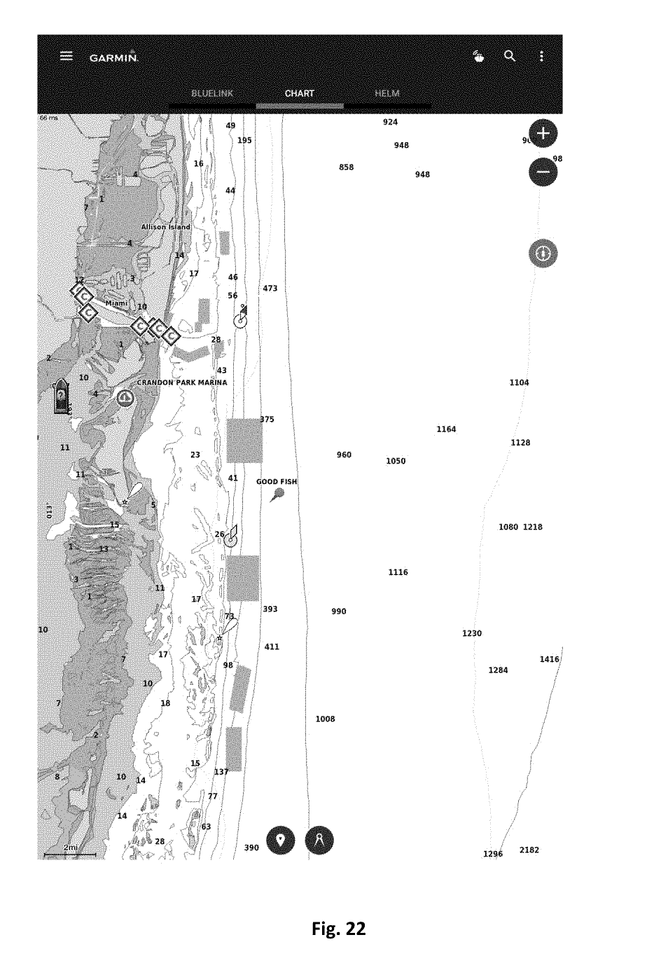

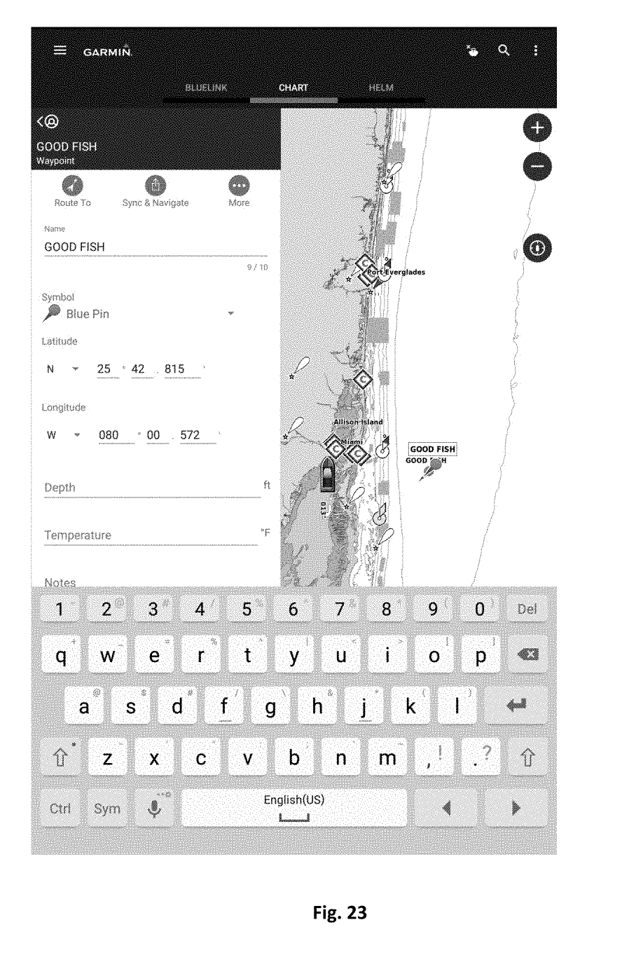

Features of the present technology related to user-community marine data are further illustrated and described with reference to FIGS. 10-25, which illustrate screen shots of the user's mobile communications device 14 having the mobile software application installed and running thereon.

FIG. 10 illustrates a home screen of the mobile software application of the present technology. A menu 130 enables access to mobile application features indicated as (i) “My Garmin Products” at tab 132 for accessing information regarding registered marine electronic navigation devices 42, (ii) “One Chart” at tab 134 for accessing marine cartography and related information, (iii) “Quickdraw Community” at tab 136 for accessing user-community features described herein, and (iv) “User Data Sync” at tab 138 for accessing the user's marine data and for managing data synchronization in system 10. Menu 130 further enables accessing digital charts and for viewing chart information (at menu item “Chart”) and helm-related information (at menu item “Helm”).

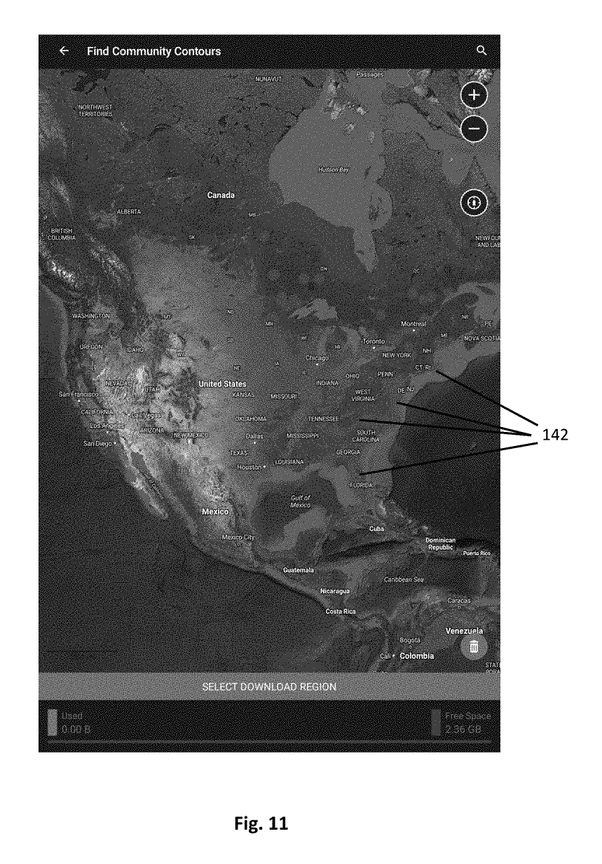

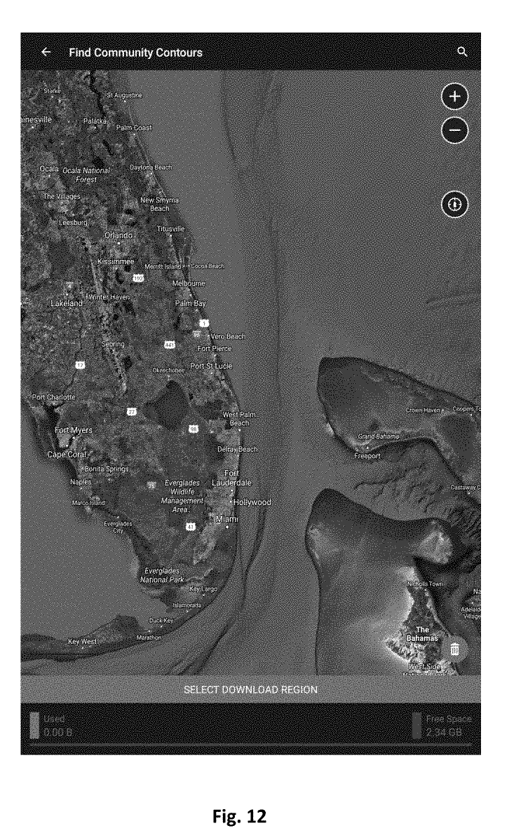

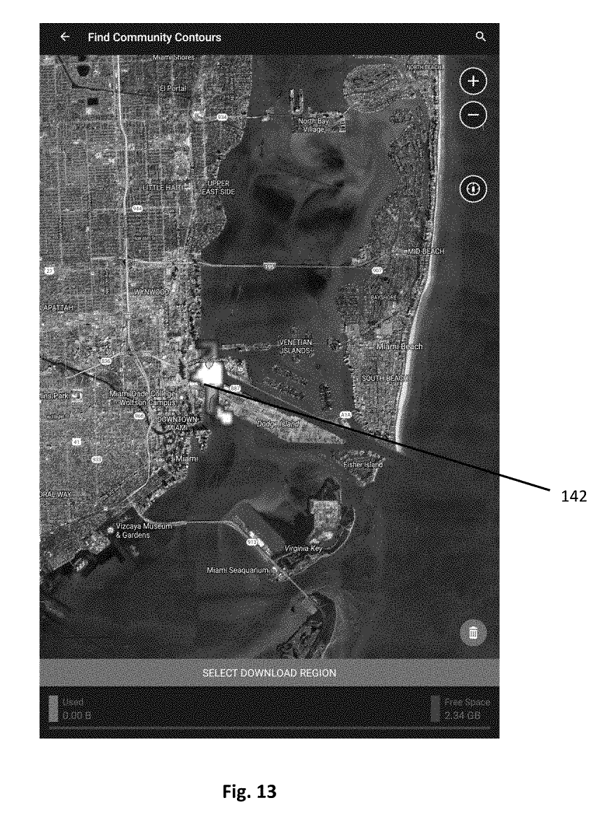

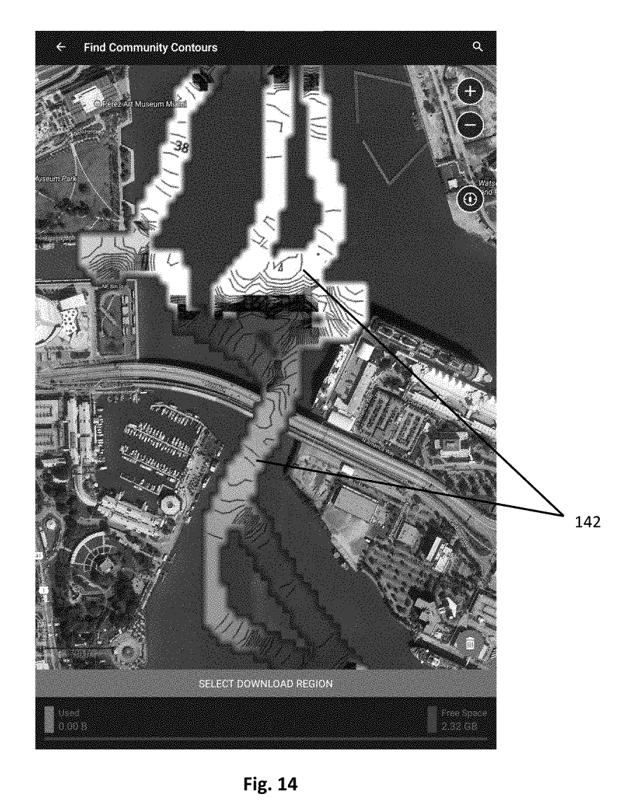

As illustrated in FIG. 11, a digital map is displayed on the display of mobile communications device 14. Overlaying the map are colored dots 140. The colored dots 140 indicate geographic areas in which users of the user community have uploaded marine user data that is available to be downloaded and shared with other users of the user community. FIG. 12 illustrates the display of mobile communications device 14 zoomed-in on a map illustrating available marine user data on the southern peninsula of the state of Florida, USA. FIG. 13 illustrates the display of mobile communications device 14 further zoomed-in on the map illustrating available marine user data in an area around Miami, Fla. USA and further illustrating in greater detail uploaded marine user data indicative of a historical travel path 142 of a vessel 38, such as 38A. FIG. 14 illustrates the display of the mobile communications device 14 even further zoomed-in on the historical travel path 142 that was uploaded by a user of the user community.

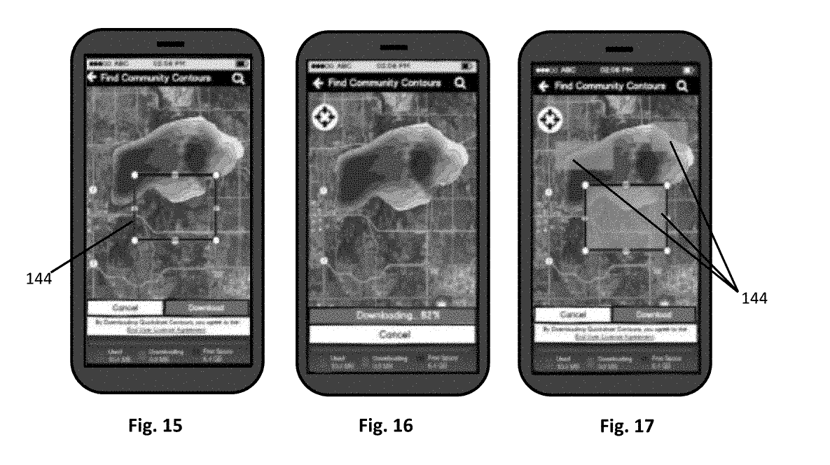

As described herein, system 10, including particularly the mobile software application, enables the user of mobile communications device 14 to select a region for downloading of the user data that has been uploaded to the selected region. FIG. 15 illustrates a geographic region that is different than the geographic region near Miami, Fla., USA as illustrated in FIGS. 11-14. As illustrated in FIG. 15, the user has selected a geographic region by drawing a box-shaped region 144 indicative of the geographic area for which the user wishes to download user-community marine data that has been uploaded to system 10. As illustrated in FIG. 16, the user-community marine data associated with the selected region 144 is downloading to the mobile communications device 14. FIG. 17 illustrates the region 144 being indicated in a color that is indicative of a region for which user community marine data has been downloaded to mobile communications device 14. FIG. 17 also illustrates other regions that the user has identified as areas for which user community marine data is desired to be downloaded and has been downloaded. A further aspect of the present invention is to color-code regions selected by the user for data download. For example, a green region may be indicative of a region for which up-to-date user community marine data has already been downloaded to the device from which access is occurring. A gray region, for example, may be indicative of a region selected by the user for download of user community marine data but for which no current user community marine data exists and therefore has not yet been included in a download of user community marine data to the device from which access is occurring.

In this regard, it should be understood that access to the digital maps for accessing digital maps, user data, and for selecting regions may, in addition to occurring from the user's mobile communications device 14, occur from a marine electronic device if it is has connectivity to server 36 (such as via mobile communications device 14) or from a personal computer of the user. As such, data indicative of regions selected by a device other than mobile communications device 14 (such as, for example, a personal computer of the user) as well as marine user data corresponding to those selected regions may (for example) be downloaded to the mobile communications device 14 of the user upon the next occurrence of opening of the mobile application on the mobile communications device 14.

FIGS. 11-17 correspond to display screens of mobile communications 14 related to user access of the Quickdraw Community features noted on the home screen of FIG. 10. These Quickdraw Community features particularly relate to user-community marine data and the ability to use mobile communications device 14 to upload the user's marine user data and to select regions and download user-community marine data of other users as described herein.

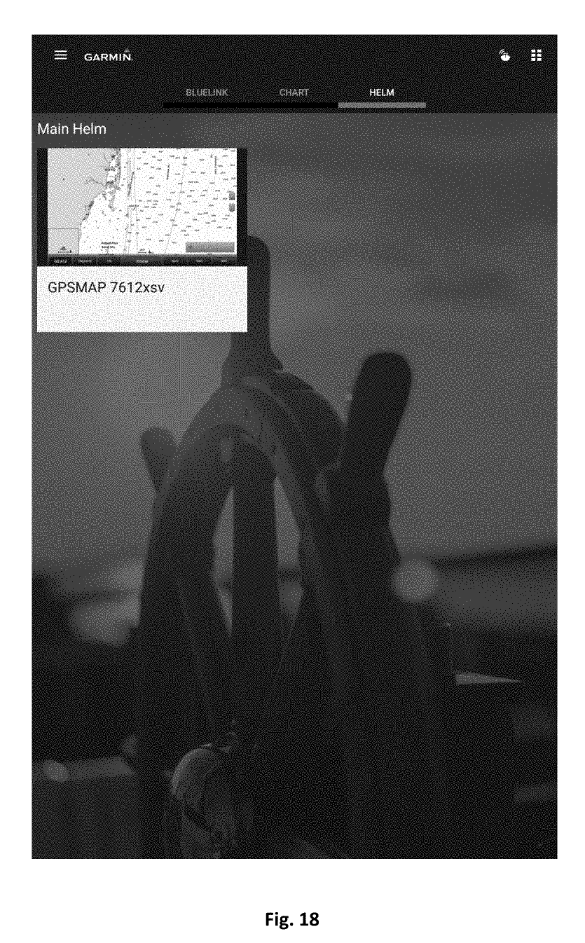

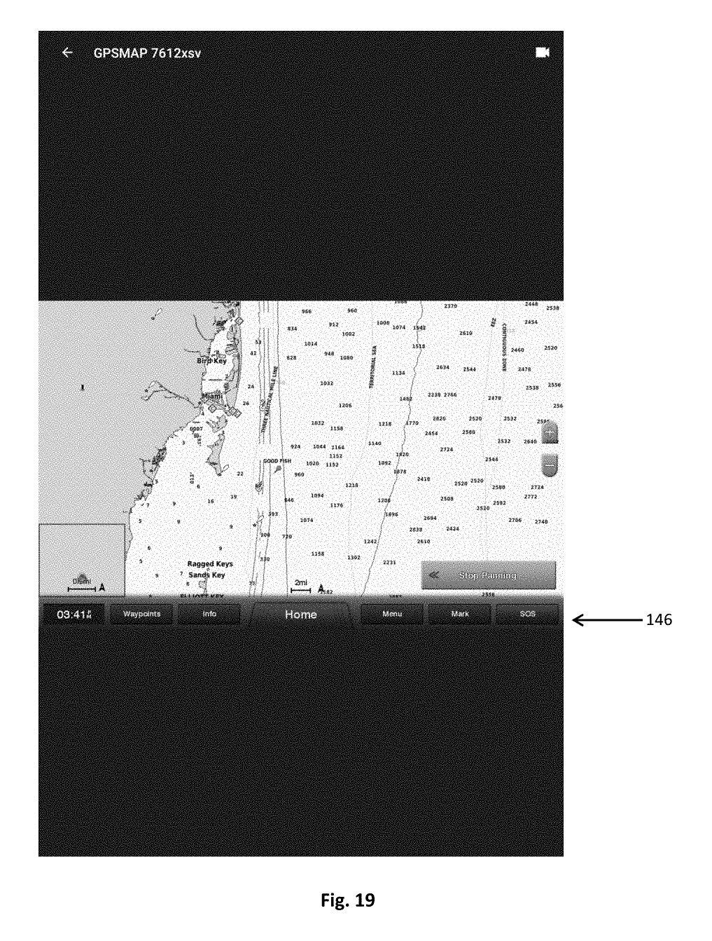

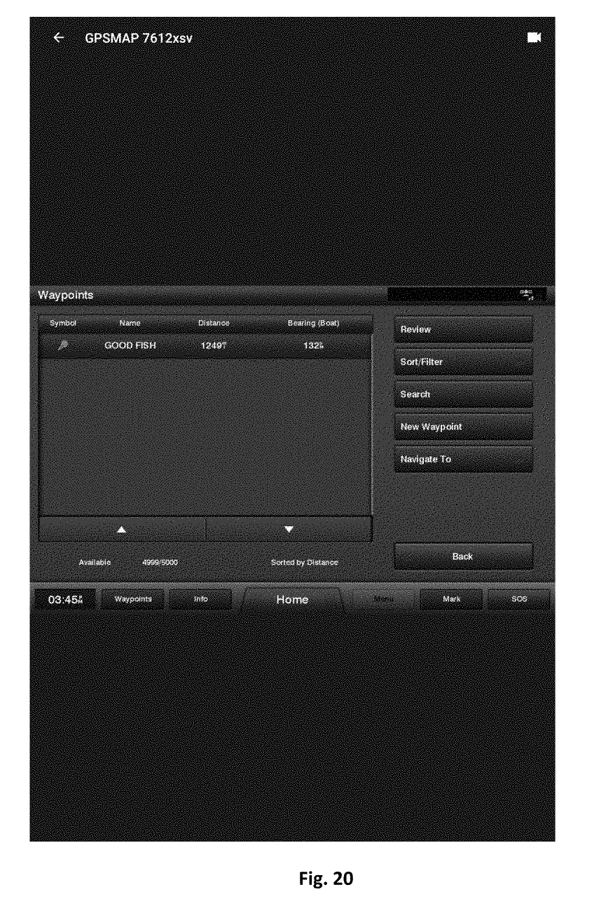

FIGS. 18-20 illustrate display screens of mobile communications device 14 indicative of the helm of a marine vessel associated with the mobile application. As shown in FIG. 18, a marine electronic device 12 of a particular type (a Garmin GPSMAP 7612xsv) and a portion of related marine cartography is shown. Selecting the particularly identified marine electronic device 12 (e.g., the Garmin GPSMAP 7612xsv) displays a larger version of the related marine cartography (and enables panning and zooming) as indicated in FIG. 19 and access to other features and information (as denoted by the menu indicated by reference numeral 146 of FIG. 19). FIG. 20 illustrates the display screen of mobile communications device 14 when the “Waypoints” tab on menu 146 is selected (e.g., displaying a waypoint named “GOOD FISH”).

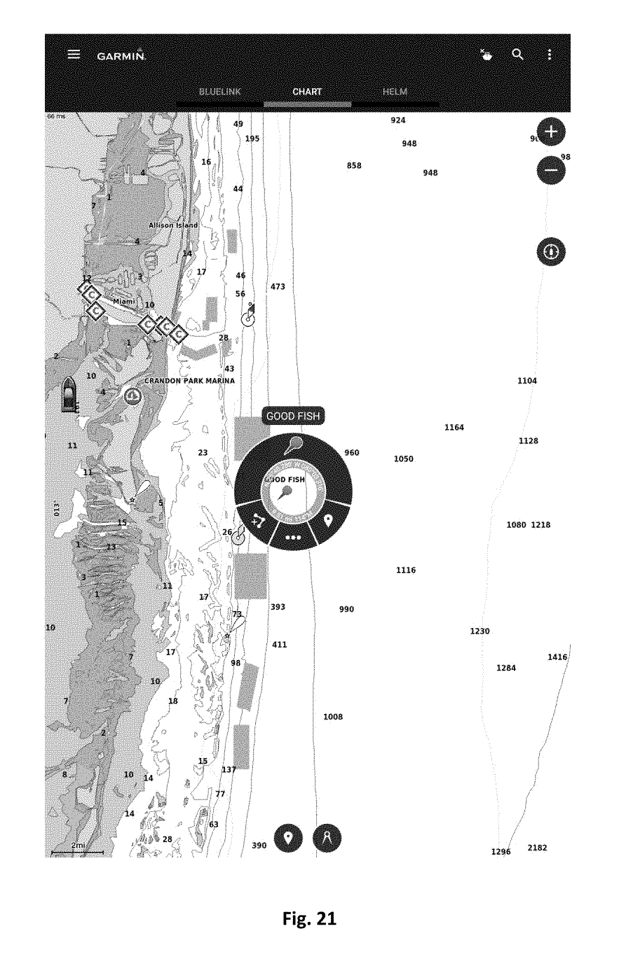

FIGS. 21-23 illustrate display screens of mobile communications device 14 indicative of charts (including in this example the associated waypoint GOOD FISH) associated with the user account.

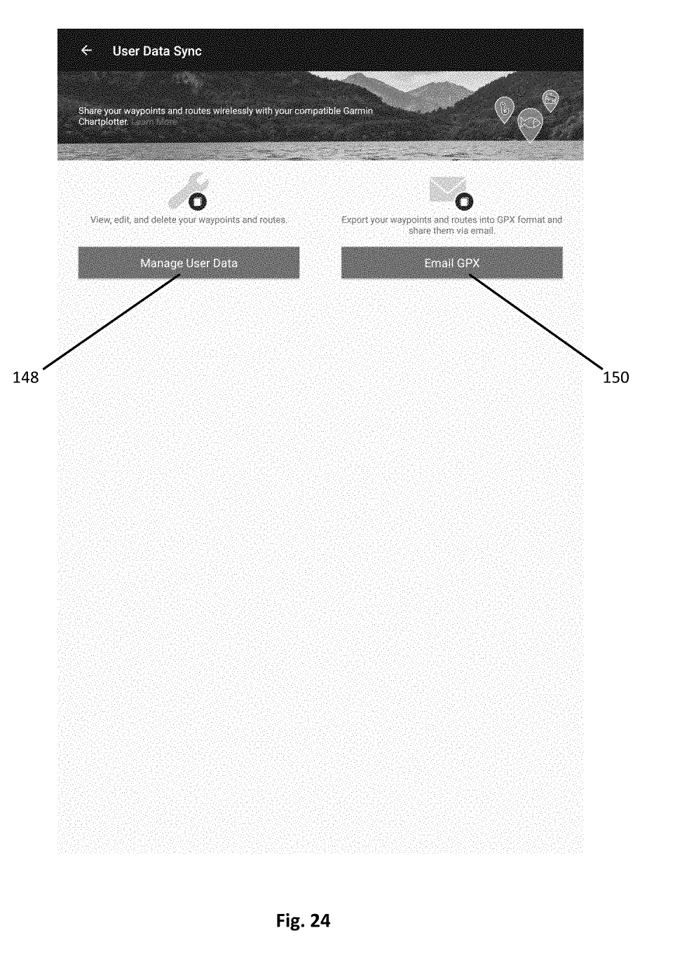

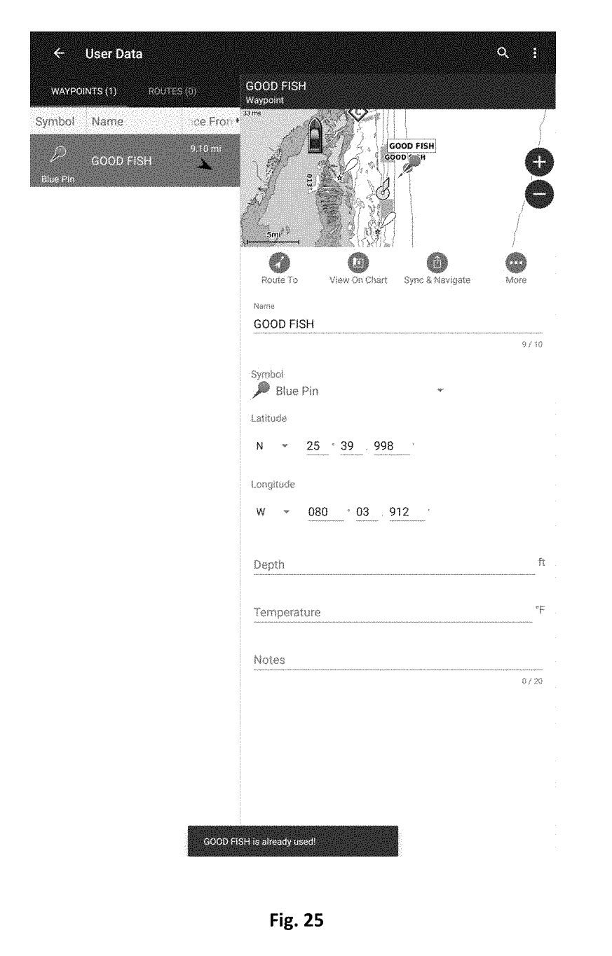

Regarding FIGS. 24 and 25, FIG. 24 illustrates an exemplary screen display when the user data sync tab 138 on the home screen of FIG. 10 is selected. This screen enables the user (i) to manage the user's data (at user selectable item 148), such as viewing, editing, and deleting the user's waypoints and routes, and (ii) to export the user's data (at user selectable item 150), such as exporting the user's waypoints and routes in a format that enables them to be easily shared via electronic communication such as e-mail. FIG. 25 illustrates an exemplary display screen when the user has selected the selectable item 148 to manage the user's data and, in particular, displays information indicative of the user's GOOD FISH waypoint and related features and selectable functionality.

Some portions of the detailed descriptions herein, possibly including but not necessarily limited to those portions relating to illustrated flowcharts, are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In some embodiments, the inventive subject matter is described in the general context of computer-executable instructions, such as program modules, being executed by a computer or an electronic processor or electronic processing system. Generally, program modules include routines, programs, objects, components, data structures, etc., that perform particular tasks or implement particular abstract data types. As indicated above, the system 10 as disclosed herein utilizes a distribute environment and processing can occur across multiple physical hosts such that, for example, processing of data synchronization occurs on one or the other or both of a marine electronics device or system 12 and a mobile communications device 14. Therefore, many systems and sub-systems can be involved in implementing the inventive subject matter disclosed herein. Additionally, in a distributed computing environment as described herein, program modules may be located in both local and remote memory storage devices and particular device may operate in the capacity of a server or a client machine in server-client network environment, or as a peer machine in a peer-to-peer (or distributed) network environment. Further, the term “machine” or “device” shall also be taken to include any collection of machines or devices that individually or jointly execute a set (or multiple sets) of instructions to perform any one or more of the methodologies and/or processes discussed herein.

One or more memories, memory units, and/or memory devices as described herein comprise a machine-readable medium on which is stored one or more sets of instructions and data structures (e.g., software instructions) embodying or used by any one or more of the methodologies or functions described herein. The instructions may also reside, completely or at least partially, within a main memory or within an electronic processor of a device during execution thereof, such that a memory unit as well as an electronic processor or server may also constituting machine-readable media. The term “machine-readable medium” may include a single medium or multiple media (e.g., a centralized or distributed database, or associated caches and and/or servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” or “technology” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and equivalents, as well as applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A system comprising:
a marine communications network enabling wireless communications functionality on a marine vessel;
an electronic navigation device installed on the marine vessel comprising a processor and a memory storing a first marine data set; and
a mobile communications device comprising a processor and a memory storing a second marine data set and a mobile software application including a set of instructions executed by the processor for synchronizing, using the marine communications network, the first marine data set stored on the electronic marine navigation device with the second marine data set.

2. The system of claim 1, wherein said first and second marine data sets comprise at least one of waypoint data, point of interest data, boundary data, coastline or shoreline data, navigation route data, historical track data, and guidance path data.

3. The system of claim 1, wherein said system further comprises an electronic server comprising a memory including the second marine data set, wherein said second marine data set includes marine data that has been uploaded to said electronic server from one or more electronic devices other than said electronic navigation device and said mobile communications device, and wherein said second marine data set is associated with a geographic area.

4. The system of claim 3, wherein said second marine data set is a data update of marine data for storage on the memory of the electronic navigation device.

5. The system of claim 4, wherein said data update comprises marine cartographic data within a range of a geographic location associated with the marine vessel.

6. The system of claim 3, wherein the marine data includes a plurality of items, wherein each item of said plurality of items is identified by an identifier and a version number.

7. The system of claim 6, wherein the processor of the electronic navigation device combines at least a portion of the second marine data set with the first marine data set when the processor of the electronic navigation device determines that the identifiers or version numbers associated with the first and second marine data sets do not match.

8. The system of claim 7, wherein the combined first marine data set corresponds to the second marine data set stored in the electronic server.

9. The system of claim 7—
wherein each item of said plurality of items of said first marine data set stored in said electronic navigation device comprises an updatable version identifier that is indicative of the version of that item as currently stored in said electronic navigation device,
wherein each item of said plurality of items of said second marine data set stored in said mobile communications device comprises an updatable version identifier that is indicative of the version of that item as currently stored in said mobile communications device.

10. The system of claim 7, wherein the combined first marine data set comprises data associated with a greater updatable version identifier associated with a particular item based upon a comparison of (i) the updatable version identifier for said particular item as indicated in said first marine data set stored in said electronic navigation device and (ii) the updatable version identifier for said particular item as indicated in said second marine data set stored in said mobile communications device.

11. The system of claim 1, wherein the memory of the mobile communications device includes a user-role permitting data transfer between the first mobile communications device and the electronic navigation device.

12. A system comprising:
a marine communications network enabling wireless communications functionality on a marine vessel;
an electronic navigation device for the marine vessel comprising a processor and a memory storing a first set of marine data comprised of a plurality of items;
a mobile communications device comprising a processor and a memory storing a second set of marine data and a mobile software application including instructions executed by the processor of the mobile communication device to
receive and store, using the marine communications network, a marine data set comprised of marine data indicative of at least a portion of said plurality of items,
determine whether the second set of marine data matches the first set of marine data, and
create a new data set based on a combination of at least a portion of the first set of marine data and the second set marine data when the first set of marine data and the second set of marine data do not match.

13. The system of claim 12, wherein said system further comprises an electronic server, wherein said second marine data set received and stored in the memory of the mobile communications device includes marine data that has been uploaded to said electronic server from one or more electronic devices other than said electronic navigation device and said mobile communications device, and wherein the second marine data set is associated with a geographic location.

14. The system of claim 12, wherein the second marine data set originated from a second electronic navigation device.

15. The system of claim 12, wherein said marine data set received and stored in said mobile communications device comprises marine cartographic data within a range of a geographic location associated with the marine vessel.

16. The system of claim 12, wherein each item of said plurality of items is identified by an identifier and a version number.

17. The system of claim 13, wherein said new set of data corresponds to the second set of marine data stored in the electronic server.

18. The system of claim 12—
wherein each item of said plurality of items of said set of marine data stored in said electronic navigation device comprises an updatable version identifier that is indicative of the version of that item as currently stored in said electronic navigation device,
wherein each item of said plurality of items of said marine data set received and stored in said mobile communications device comprises an updatable version identifier that is indicative of the version of that item as currently stored in said mobile communications device.

19. The system of claim 12, wherein said new set of data comprises data associated with a greater updatable version identifier associated with a particular item based upon a comparison of (i) the updatable version identifier for said particular item as indicated in said marine data stored in said electronic navigation device and (ii) the updatable version identifier for said particular item as indicated in said marine data set stored in said mobile communications device.

20. A system comprising:
a marine communications network enabling wireless communications functionality on a marine vessel;
an electronic navigation system installed on the marine vessel comprising a processor and a memory storing a first marine data set comprised of a plurality of items, wherein each item of said plurality of items of said set of marine data stored in said electronic navigation system comprises an updatable version identifier that is indicative of a version of that item as currently stored in said electronic navigation system; and
a mobile communications device comprising a processor and a memory storing a mobile software application executed by the processor to
receive and store a marine data set comprised of data that is indicative of at least a portion of said plurality of items and an updatable version identifier that is indicative of the version of that item as currently stored in said mobile communications device,
generate a new set of data comprising marine data set associated with at least one of the updatable version identifier and one of a first timestamp and a second timestamp that is indicative of a latest data update to said particular one of said items.
